(19) United States
(12) Patent Application Publication
(10) Pub. No.: US 2012/0110219 A1
(43) Pub. Date: May 3, 2012

(54) DATA PROCESSING CIRCUIT AND DATA PROCESSING APPARATUS

(75) Inventor: Kouji YAMAKI, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/287,855

(22) Filed: Nov. 2, 2011

Related U.S. Application Data
(60) Provisional application No. 61/409,932, filed on Nov. 3, 2010.

(51) Int. Cl. G06F 13/14

(52) U.S. Cl. 710/32

(57) ABSTRACT

According to one embodiment, a data processing circuit included in a data processing apparatus together with plural peripheral circuits including a peripheral circuit configured to output first data includes a processing unit and a stop unit. The processing unit subjects the first data to data processing according to a specified processing algorithm to obtain second data. The stop unit stops the output of the second data to the outside of the data processing circuit in a stop period excluding a period from the time when the plural peripheral circuits finish starting in specified start order until the time when a specified time elapses after the plural peripheral circuits finish stopping in specified stop order.

### CROSS-REFERENCE TO RELATED APPLICATIONS

This application is based upon and claims the benefit of priority from U.S. provisional application 61/409,932, filed on Nov. 3, 2010, the entire contents of which are incorporated herein by reference.

### FIELD

Embodiments described herein relate generally to a data processing circuit and a data processing apparatus.

### BACKGROUND

A data processing circuit configured making use of an application-specific integrated circuit (ASIC) has high confidentiality of a circuit configuration thereof.

However, according to the progress of analysis technologies in recent years, an algorithm of data processing is likely to be analyzed on the basis of input and output data.

Under such circumstances, it is demanded that the secrecy of the algorithm can be maintained by preventing the algorithm from being easily analyzed by the method explained above.

### BRIEF DESCRIPTION OF THE DRAWINGS

FIG. 1 is a block diagram of a multi function peripheral (MFP);

FIG. 2 is a block diagram of an image processing ASIC shown in FIG. 1;

FIG. 3 is an operation time chart of the image processing ASIC shown in FIG. 1; and

FIG. 4 is an operation time chart of the image processing ASIC shown in FIG. 1.

### DETAILED DESCRIPTION

In general, according to one embodiment, a data processing circuit included in a data processing apparatus together with plural peripheral circuits including a peripheral circuit configured to output first data includes a processing unit and a stop unit. The processing unit subjects the first data to data processing according to a specified processing algorithm to obtain second data. The stop unit stops the output of the second data to the outside of the data processing circuit in a stop period excluding a period from the time when the plural peripheral circuits finish starting in specified start order until the time when a specified time elapses after the plural peripheral circuits finish stopping in specified stop order.

An embodiment is explained below with reference to the accompanying drawings.

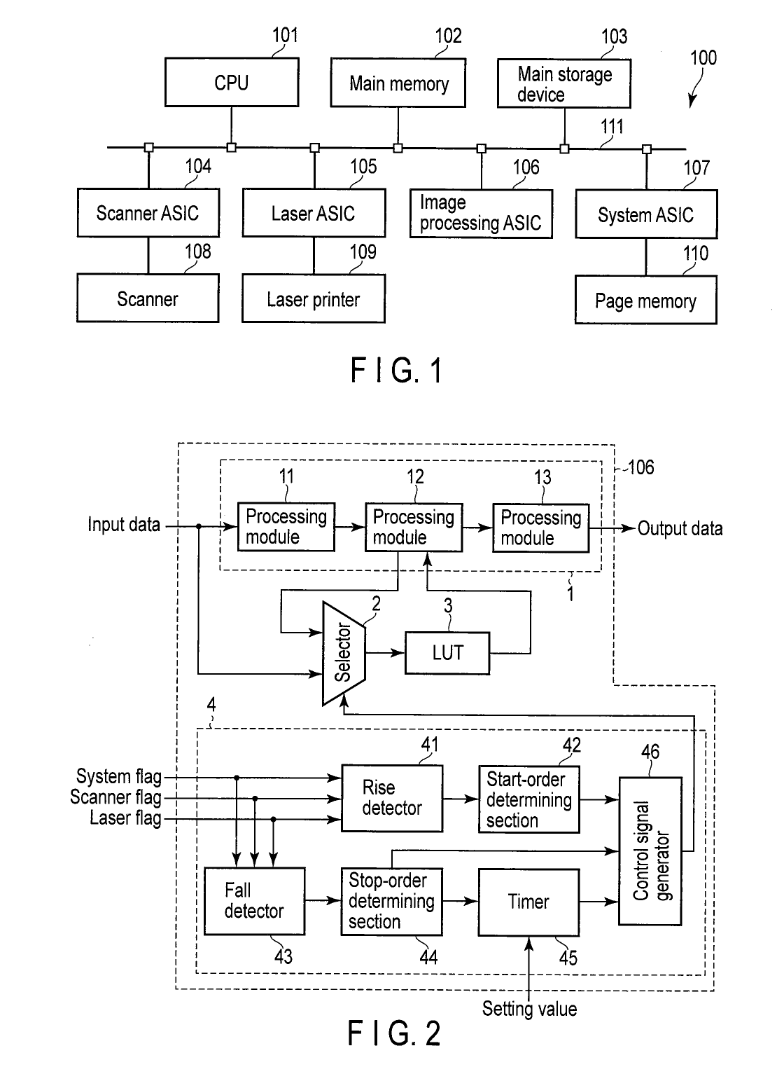

FIG. 1 is a block diagram of a multi function peripheral (MFP) 100.

The MFP 100 is an example of a data processing apparatus. The MFP 100 includes a central processing unit (CPU) 101, a main memory 102, a main storage device 103, a scanner ASIC 104, a laser ASIC 105, an image processing ASIC 106, a system ASIC 107, a scanner 108, a laser printer 109, and a page memory 110. The CPU 101, the main memory 102, the main storage device 103, the scanner ASIC 104, the laser ASIC 105, the image processing ASIC 106, and the system ASIC 107 are connected to a bus 111.

The CPU 101 controls the components included in the MFP 100 on the basis of an operating system, middleware, and application programs stored in the main memory 102 in order to realize various operations of the MFP 100.

The main memory 102 stores therein the operating system, the middleware, and the application programs. In some case, the main memory 102 stores therein data referred to by the CPU 101 in performing various kinds of processing.

The main storage device 103 is, for example, a hard disk drive or an SSD (solid state drive). The main storage device 103 stores data used by the CPU 101 in performing the various kinds of processing and data generated by the processing in the CPU 101.

All of the scanner ASIC 104, the laser ASIC 105, the image processing ASIC 106, and the system ASIC 107 are processing circuits that make use of ASICs. The image processing ASIC 106 is an example of a data processing circuit. The scanner ASIC 104, the laser

ASIC 105, and the system ASIC 107 are examples of peripheral circuits of the data processing circuit.

The scanner ASIC 104 performs well-known processing related to the operation of the scanner 108.

The laser ASIC 105 performs well-known processing related to the operation of the laser printer 109.

The image processing ASIC 106 applies data processing to image data.

The system ASIC 107 performs well-known processing related to the operation of the page memory 110 and well-known processing related to image encoding.

The scanner 108 scans an image formed on an original document and generates image data.

The laser printer 109 prints the image represented by the image data on a print medium.

The page memory 110 stores the image data.

FIG. 2 is a block diagram of the image processing ASIC 106.

The image processing ASIC 106 includes a processing unit 1, a selector 2, a look up table (LUT) 3, and a controller 4.

The processing unit 1 obtains output data by applying data processing set in advance to image data (input data) given from any one of the scanner ASIC 104, the laser ASIC 105, and the system ASIC 107. The output data is given to any one of the scanner ASIC 104, the laser ASIC 105, and the system ASIC 107. The configuration and processing content of the processing unit 1 may be arbitrary. In FIG. 2, the processing unit 1 includes three processing modules 11, 12, and 13. The processing modules 11, 12, and 13 are connected in series. The processing unit 1 obtains the output data from the input data by performing the data processing stepwise with the processing modules 11, 12 and 13. In particular, the processing module 12 outputs address data obtained on the basis of data output by the processing module 11 and obtains data to be output to the processing module 13 making use of data output by the LUT 3 at this point.

The selector 2 selects one of the address data output from the processing module 12 and input data to the image processing ASIC 106 and gives the LUT 3 the selected data as address data. The selector 2 selects one of the two data according to a level of a control signal given from the controller 4. In this embodiment, if the control signal is at a high level, the selector 2 selects the address data output from the processing module 12. If the control signal is at a low level, the selector 2 selects the input data to the image processing ASIC 106.

The LUT 3 stores data respectively in plural address spaces. The LUT 3 outputs data stored in an address space of the LUT 3 designated by the address data given from the selector 2.

The controller 4 includes a rise detector 41, a start-order determining section 42, a fall detector 43, a stop-order determining section 44, a timer 45, and a control signal generator 46.

A system flag, a scanner flag, and a laser flag are input to the rise detector 41 and the fall detector 43. The system flag indicates, with a difference in a level, whether the system ASIC 107 is in operation. The scanner flag indicates, with a difference in a level, whether the scanner ASIC 104 is in operation. The laser flag indicates, with a difference in a level, whether the laser ASIC 105 is in operation. In this embodiment, in all of the system flag, the scanner flag, and the laser flag, the high level represents that the ASICs are in operation.

The rise detector 41 detects rises of the system flag, the scanner flag, and the laser flag. If the rise detector 41 detects a rise of any one of the system flag, the scanner flag, and the laser flag, the rise detector 41 gives the start-order determining section 42 a notification signal indicating which of the system flag, the scanner flag, and the laser flag the risen flag is.

The start-order determining section 42 determines, on the basis of rising order of the system flag, the scanner flag, and the laser flag, whether start order of the scanner ASIC 104, the laser ASIC 105, and the system ASIC 107 is specified order. If the start-order determining section 42 determines that the scanner ASIC 104, the laser ASIC 105, and the system ASIC 107 finish starting in the specified order, the start-order determining section 42 outputs a start signal to the control signal generator 46.

The fall detector 43 detects falls of the system flag, the scanner flag, and the laser flag. If the fall detector 43 detects a fall of any one of the system flag, the scanner flag, and the laser flag, the fall detector 43 gives the stop-order determining section 44 a notification signal indicating which of the system flag, the scanner flag, and the laser flag the fallen flag is.

The stop-order determining section 44 determines, on the basis of falling order of the system flag, the scanner flag, and the laser flag, whether stop order of the scanner ASIC 104, the laser ASIC 105, and the system ASIC 107 is specified order. If the stop-order determining section 44 determines that the scanner ASIC 104, the laser ASIC 105, and the system ASIC 107 finish stopping in the specified order, the stop-order determining section 44 starts the timer 45. If the stop-order determining section 44 confirms that the stop order of the scanner ASIC 104, the laser ASIC 105, and the system ASIC 107 is not the specified order, the stop-order determining section 44 outputs a stop signal to the control signal generator 46.

The timer 45 measures time until a specified time elapses after the timer 45 is started by the stop-order determining section 44. At a point when the specified time elapses, the timer 45 outputs the stop signal to the control signal generator 46.

The control signal generator 46 sets the control signal to the high level in a period until the stop signal is given after the start signal is given and sets the control signal to the low level in other periods.

The processing unit 1 is typically used in a use for receiving, as input data, image data given from the scanner ASIC 104 and giving the system ASIC 107 output data. However, the processing unit 1 may be used in a use different from the use. Plural sets of the processing unit 1, the selector 2, and the LUT 3 may be provided and respectively used in uses different from one another. In this case, a control signal output by one controller 4 may be given to each of the plural selectors 2 or plural control signals output by plural controllers 4 may be respectively given to the plural selectors 2.

The operations of the MFP 100 configured as explained above are explained. Most of the operations of the MFP 100 may be the same as those of the existing MFP. A characteristic operation in the MFP 100 is an operation in the image processing ASIC 106. Therefore, the operation of the image processing ASIC 106 is explained in detail below.

In a regular operation of the MFP 100, the scanner ASIC 104, the laser ASIC 105, and the system ASIC 107 sequentially start in specified start order. As an example, it is assumed that the system ASIC 107 starts first, the scanner ASIC 104 starts next, and the laser ASIC 105 starts last.

In a state in which the scanner ASIC 104, the laser ASIC 105, and the system ASIC 107 are stopped and all of the scanner flag, the laser flag, and the system flag are at the low level, the control signal generator 46 sets the control signal to the low level.

If any one of the scanner ASIC 104, the laser ASIC 105, and the system ASIC 107 starts and any one of the scanner flag, the laser flag, and the system flag rises to the high level, the rise detector 41 detects the rise of the flag. The rise detector 41 gives the start-order determining section 42 a notification signal indicating which of the scanner flag, the laser flag, and the system flag the risen flag is.

If the start-order determining section 42 receives the notification signal, the start-order determining section 42 updates start order data representing the order of the rises of the flags. The start order data is stored in a memory, a register, or the like included in the start-order determining section 42. In a state in which all of the scanner flag, the laser flag, and the system flag are at the low level, the start order data indicates that none of the flags rises. For example, if the system flag changes to the high level from this state, the start-order determining section 42 updates the start order data to indicate that the system flag changes to the high level first. The start-order determining section 42 checks whether all of the scanner flag, the laser flag, and the system flag rise. If all of the scanner flag, the laser flag, and the system flag rise, the start-order determining section 42 checks whether the order of the rises of the flags conforms to the specified start order. Theses checks can be performed by, for example, referring to the start order data. If the order of the rises of the scanner flag, the laser flag, and the system flag conforms to the specified start order, the start-order determining section 42 determines that the scanner ASIC 104, the laser ASIC 105, and the system ASIC 107 finish starting in the specified start order. Only if the start-order determining section 42 determines in this way, the start-order determining section 42 outputs a start signal to the control signal generator 46.

If the control signal generator 46 receives the start signal, the control signal generator 46 changes the control signal to the high level.

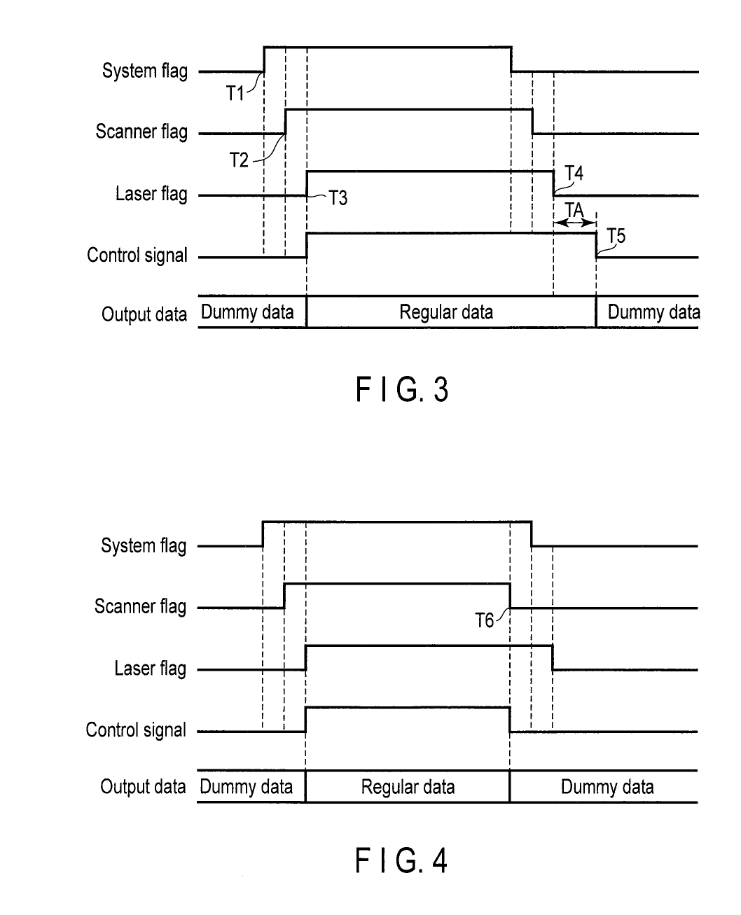

Consequently, as shown in FIG. 3, even if one or two of the scanner flag, the laser flag, and the system flag rise, unless the other flag(s) rises, the control signal remains at the low level (timings T1 and T2). Even if all of the scanner flag, the laser flag, and the system flag rise, unless the order of the rises of the flags conforms to the specified start order, the control signal remains at the low level. If all of the scanner flag, the laser flag, and the system flag finish rising in the specified order, the control signal is changed to the high level (timing T3).

If the control signal is at the high level, the selector 2 gives the LUT 3 the address data output by the processing module 12. The LUT 3 outputs data stored in an address space of the LUT 3 designated by the address data, which is given from the selector 2, to the processing module 12. Consequently, the processing module 12 can correctly acquire data associated in advance with the address data output by the processing module 12. The processing module 12 performs data processing making use of the data correctly acquired in this way, whereby data processing in the processing unit 1 conforms to a processing algorithm set in advance. In other words, the output data from the processing unit 1 is regular data obtained by applying the data processing conforming to the processing algorithm set in advance to the input data.

In the regular operation of the MFP 100, the scanner ASIC 104, the laser ASIC 105, and the system ASIC 107 sequentially stop in specified stop order. As an example, it is assumed that the system ASIC 107 stops first, the scanner ASIC 104 stops next, and the laser ASIC 105 stops last.

If any one of the scanner ASIC 104, the laser ASIC 105, and the system ASIC 107 stops and any one of the scanner flag, the laser flag, and the system flag falls to the low level, the fall detector 43 detects the fall of the flag. The fall detector 43 gives the stop-order determining section 44 a notification signal indicating which of the scanner flag, the laser flag, and the system flag the fallen flag is.

If the stop-order determining section 44 receives the notification signal, the stop-order determining section 44 updates stop order data representing the order of the falls of the flags. The stop order data is stored in a memory, a register, or the like included in the stop-order determining section 44. In a state in which all of the scanner flag, the laser flag, and the system flag are at the high level, the stop order data indicates that none of the flags falls. For example, if the system flag changes to the low level from this state, the stop-order determining section 44 updates the stop order data to indicate that the system flag changes to the low level first. Further, the stop-order determining section 44 checks whether all of the scanner flag, the laser flag, and the system flag fall.

If all of the scanner flag, the laser flag, and the system flag fall, the stop-order determining section 44 checks whether the order of the falls of the flags conforms to the specified stop order. These checks can be performed by, for example, referring to the stop order data. If the order of the falls of the scanner flag, the laser flag, and the system flag conforms to the specified stop order, the stop-order determining section 44 determines that the scanner ASIC 104, the laser ASIC 105, and the system ASIC 107 finish stopping in the specified stop order. Only if the stop-order determining section 44 determines in this way, the stop-order determining section 44 starts the timer 45.

At a point when a specified time TA elapses after the timer 45 is started by the stop-order determining section 44, the timer 45 outputs a stop signal to the control signal generator 46. The timer 45 stores a setting value given from the outside in the register. The timer 45 sets time corresponding to the stored setting value as the time TA. Therefore, a user can arbitrarily change the time TA by arbitrarily changing the setting value. The time TA can also be set to 0. In this case, at a point when the scanner ASIC 104, the laser ASIC 105, and the system ASIC 107 finish stopping in the specified stop order, the stop signal is output from the timer 45 to the control signal generator 46.

If the control signal generator 46 receives the stop signal, the control signal generator 46 changes the control signal to the low level.

Consequently, as shown in FIG. 3, even if all of the scanner flag, the laser flag, and the system flag finish falling in regular stop order (timing T4), the control signal remains at the high level. If the time TA elapses from timing T4, the control signal is changed to the low level (timing T5).

If the control signal is at the low level, the selector 2 gives the LUT 3 the input data to the processing unit 1 as address data. Consequently, the processing module 12 cannot correctly acquire data associated in advance with the address data output by the processing module 12. The processing module 12 performs data processing making use of the wrong data acquired in this way, whereby the data processing in the processing unit 1 does not conform to the processing algorithm set in advance. In other words, the output data from the processing unit 1 is dummy data obtained by applying the data processing not conforming to the processing algorithm set in advance to the input data. In this way, the output of the regular data obtained by the processing unit 1 is stopped by the workings of the selector 2 and the controller 4. Consequently, the selector 2 and the controller 4 function as a stop unit.

On the other hand, every time any one of the scanner flag, the laser flag, and the system flag falls, the stop-order determining section 44 checks whether the order of the falls of the flags fallen till that time conforms to the specified stop order. If the order of the falls of the flags does not conform to the specified stop order, the stop-order determining section 44 outputs the stop signal to the control signal generator 46 at the point of the falls of the flags.

In FIG. 4, the scanner flag falls prior to the system flag. In such a case, the stop-order determining section 44 outputs the stop signal to the control signal generator 46 at timing T6 when the scanner flag falls. According to the stop signal, the control signal generator 46 changes the control signal to the low level at timing T6. Therefore, the output of the regular data from the processing unit 1 is immediately stopped at timing T6.

As explained above, in the MFP 100, only if the scanner ASIC 104, the laser ASIC 105, and the system ASIC 107 finish starting in the specified start order, the image processing ASIC 106 outputs the regular data obtained by the data processing conforming to the regular processing algorithm. Therefore, in a situation in which the image processing ASIC 106 is removed from the MFP 100 and an operation analysis is attempted by the image processing ASIC 106 alone, the image processing ASIC 106 does not output the regular data. Therefore, it is possible to prevent a processing algorithm in the image processing ASIC 106 from being analyzed from the output data of the image processing ASIC 106.

Further, the image processing ASIC 106 outputs the dummy data in a period in which the output of the regular data is stopped. Therefore, only by glancing at the operation of the image processing ASIC 106, it is not seen that the measures for preventing an operation analysis is taken. Therefore, it is possible to make the operation analysis more difficult.

Moreover, in the image processing ASIC 106, the dummy data is generated by making the address data given to the LUT 3 wrong. Therefore, it is unnecessary to provide anew a processing circuit for generating the dummy data. Since the dummy data is generated by processing same as the processing for the regular data, a change in the output data with respect to a change in the input data is similar in the regular data and the dummy data. It is not easily seen that the dummy data is output. Therefore, it is possible to make the operation analysis more difficult.

Even if all of the scanner flag, the laser flag, and the system flag finish falling in the regular stop order, the image processing ASIC 106 continues to output the regular data until the time TA elapses from the end of the fall. Consequently, even if the other ASICs are in a stop state because of sleep or the like, it is possible to continue the output of the regular data for a fixed period.

If any one of the scanner flag, the laser flag, and the system flag falls without conforming to the regular stop order, the image processing ASIC 106 stops the output of the regular data at the point of the fall of the flag. Therefore, in a situation in which any one of the scanner ASIC 104, the laser ASIC 105, and the system ASIC 107 is replaced with an analyzing device configured to pretend to be the ASIC and analyze the operation of the image processing ASIC 106, it is possible to stop the regular data and prevent the operation analysis.

Since the time TA measured by the timer 45 is variable, it is possible to appropriately adjust, according to a desire of the user, the length of a period in which the regular data continues to be output after the scanner ASIC 104, the laser ASIC 105, and the system ASIC 107 finish stopping in the specified stop order. Therefore, it is possible to perform a proper operation according to, for example, content of the processing in the processing unit 1.

Various modifications of this embodiment are possible as explained below.

The time TA may be fixed to 0 without providing the timer 45.

The output to the outside of the image processing ASIC 106 of the data output by the processing unit 1 may be simply stopped without outputting the dummy data.

A processing module configured to generate the dummy data may be separately provided.

In the ASICs configured to perform the data processing other than the image processing, it is possible to adopt the configuration based on the technical idea of the embodiment.

In a data processing circuit not including an ASIC, it is possible to adopt the configuration based on the technical idea of the embodiment.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing circuit included in a data processing apparatus together with plural peripheral circuits including a peripheral circuit configured to output first data, the data processing circuit comprising:
a processing unit configured to subject the first data to data processing according to a specified processing algorithm to obtain second data; and
a stop unit configured to stop output of the second data to an outside of the data processing circuit in a stop period excluding a period from time when the plural peripheral circuits finish starting in specified start order until time when a specified time elapses after the plural peripheral circuits finish stopping in specified stop order.

2. The circuit of claim 1, wherein the specified time is 0.

3. The circuit of claim 1, wherein the specified time is other than 0.

4. The circuit of claim 1, wherein the specified time is variable.

5. The circuit of claim 1, wherein the stop unit maintains the stop period even after any one of the plural peripheral circuits stops without conforming to the stop order.

6. The circuit of claim 1, wherein the stop unit outputs data different from the second data to the outside of the data processing circuit if the output of the second data is stopped.

7. The circuit of claim 6, further comprising a look up table configured to output fourth data corresponding to input third data, wherein
the stop unit gives the look up table fifth data as the third data in a period other than the stop period and gives the look up table data different from the fifth data as the third data in the stop period, and
the processing unit obtains the second data making use of the fourth data output by the look up table when the processing unit outputs the fifth data obtained on the basis of the first data.

8. The circuit of claim 7, wherein the stop unit gives the look up table the first data as the third data.

9. The circuit of claim 7, wherein the stop unit maintains the stop period even after any one of the plural peripheral circuits stops without conforming to the stop order.

10. A data processing circuit included in a data processing apparatus together with plural peripheral circuits including a peripheral circuit that outputs first data, the data processing circuit comprising:
a look up table configured to output fourth data corresponding to input third data;
a processing unit configured to obtain second data making use of the fourth data output by the look up table when the processing unit outputs fifth data obtained on the basis of the first data;
a selector configured to input one of the first data and the fifth data to the look up table as the third data; and
a generator configured to generate a control signal for controlling the selector to select the fifth data in a period from time when the plural peripheral circuits finish starting in specified start order until time when a specified time elapses after the plural peripheral circuits finish stopping in specified stop order and select the first data in a period other than the period.

11. A data processing apparatus comprising:
plural peripheral circuits including a peripheral circuit configured to output first data; and
a data processing circuit, wherein the data processing circuit includes:
a processing unit configured to subject the first data to data processing according to a specified processing algorithm to obtain second data; and
a stop unit configured to stop output of the second data to an outside of the data processing circuit in a stop period excluding a period from time when the plural peripheral circuits finish starting in specified start order until time when a specified time elapses after the plural peripheral circuits finish stopping in specified stop order.

12. The apparatus of claim 11, wherein the specified time is 0.

13. The apparatus of claim 11, wherein the specified time is other than 0.

14. The apparatus of claim 11, wherein the specified time is variable.

15. The apparatus of claim 11, wherein the stop unit maintains the stop period even after any one of the plural peripheral circuits stops without conforming to the stop order.

16. The apparatus of claim 11, wherein the stop unit outputs data different from the second data to the outside of the data processing circuit if the output of the second data is stopped.

17. The apparatus of claim 16, further comprising a look up table configured to output fourth data corresponding to input third data, wherein
the stop unit gives the look up table fifth data as the third data in a period other than the stop period and gives the look up table data different from the fifth data as the third data in the stop period, and
the processing unit obtains the second data making use of the fourth data output by the look up table when the processing unit outputs the fifth data obtained on the basis of the first data.

18. The apparatus of claim 17, wherein the stop unit gives the look up table the first data as the third data.

19. The apparatus of claim 17, wherein the stop unit maintains the stop period even after any one of the plural peripheral circuits stops without conforming to the stop order.
